(19) United States
(12) Patent Application Publication
(10) Pub. No.: US 2003/0148120 A1
(43) Pub. Date: Aug. 7, 2003

(54) VARNISH FOR INDUCTIVE CORE, METHOD OF MAKING THE VARNISH, AND METHOD OF MAKING AN INDUCTIVE CORE

(76) Inventor: MICHAEL GERALD MINNICK, FORT WAYNE, IN (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 09/320,717

(22) Filed: May 27, 1999

(51) Int. Cl. B32B 15/08

(52) U.S. Cl. 428/461; 307/104; 327/110; 315/4

(57) ABSTRACT

A varnish composition, an inductive core made with the varnish composition, and methods of making the varnish composition and the core. The varnish composition includes an acrylic copolymer compound, a cosolvent having at least one of amine and amide functionality, and water. The varnish composition yields high bond strength when there are extended air dry periods prior to curing.

### BACKGROUND OF THE INVENTION

The present invention relates to a varnish composition suitable for use in inductive cores for electrical equipment, such as motors, transformers, generators, or the like. More particularly, the invention relates to a varnish composition suitable for bonding laminations of an inductive core that provides sufficient bond strength after prolonged air dry times and thus facilitates batch processing of inductive cores.

Many types of electrical equipment include an inductive core on which an electrically conductive winding or coil is wound. For example, transformers, motors, and generators generally include such inductive cores. An inductive core is generally made at least in part of a ferromagnetic material, such as iron or steel. It is well known to assemble inductive cores of plural laminations, i.e. thin plates. The laminations are stacked on one another and secured to one another by welding, bolts, a tab and groove construction, a frame, or adhesives.

More recently, it has been common to coat a plurality of stacked laminations with a varnish and cure the varnish to secure the laminations to one another. This avoids the use of frames, bolts, tab and groove configurations, or welds, all which can affect the magnetic characteristics of an inductive core and increase the size and cost of an inductive core. Examples of such a varnish include acrylic-phenolic varnishes, such as RCLE 6353 made by DUPONT CAVALITE, MEN43 and MEN48 made by MADER CORSOLAC, and LUREDUR PR273 made by BASF, and acrylic varnishes, such as MEN4 made by MADER CORSOLAC. Various solvents are known for use in combination with varnish depending on the application. Often water is used as a diluent or latent “solvent” in combination with an active cosolvent.

Typically, the laminations are stacked and the varnish is sprayed, or otherwise coated, on the outer surface of the stack. The coated stack may be spun to evenly distribute the varnish and to force the varnish between the laminations. The stack of laminations coated with the varnish is then immediately conveyed to an oven for drying and curing. The stacks of laminations are handled individually and the varnish is exposed to reaction, i.e. curing, temperatures in the oven prior to any significant amount of drying, i.e. removal of water and cosolvent, and thus the glass transition temperature of the resin is not significant. This is known as an “in-line” processing method. However, vitrification of the varnish, due to air drying, prior to being subjected to reaction temperatures adversely affects the shear strength and chemical resistance of the cured varnish and thus compromises the resulting core rigidity and durability. Since the cured stack of laminations must be subjected to further processing, such as coil winding, grinding, and various finishing and handling procedures, the shear strength of the cured varnish is desirably at least 6000 lbs. to avoid skewing of the laminations and bore integrity problems in the resulting motor or other equipment. Vitrification prior to curing should be avoided to achieve this strength. However, often it is not desirable, or even possible, to avoid prolonged periods of air drying prior to subjecting the varnish to reaction temperatures when manufacturing an inductive core.

For example, in order to take advantage of economies of scale, large curing ovens are used and varnish coated stacks of laminations are batch processed. For example, one or more stacks of laminations are coated with varnish, spun to remove excess varnish, then transferred to a mobile rack for further processing, including curing in an oven. This is known as a “batch method” of manufacturing inductive cores. The rack holds plural stacks, e.g. ninety stacks of laminations or more. Because it takes a great deal of time to load the rack, the coated stacks of laminations may be exposed to room temperature, i.e. air dried, for two or more hours prior to curing. In a batch process, the use of varnishes that vitrify at room temperature, or otherwise are adversely affected by extended air drying times, substantially compromises the strength and durability of the resulting laminated stack due to the inherent air drying time of the batch process.

It is known to use RCLE 6353 made by DUPONT CAVALITE for bonding in both in-line and batch processing of inductive cores. However, RCLE 6353 is a toxic acrylonitrile and thus has become obsolete due to required handling procedures and potential injury to personnel. Obsolescence of RCLE 6353 has created the need for a varnish useful for bonding laminations of inductive cores in batch processing or other processes in which there is significant air drying time. Acrylic varnishes, such as MEN4 made by MADER CORSOLAC, impart insufficient stiffness to the lamination stack throughout winding and assembly processes. Acrylic-phenolic varnishes, such as LUREDUR PR 273L made by BASF, impart desirable core strength and rigidity when immediately cured but are adversely affected by air drying. Epoxy-phenolic varnishes, such as ISOPOXY 800 made by SCHENETADY INTERNATIONAL impart sufficient core rigidity but exhibit undesirable varnish drainage when heated and poor impact resistance during winding and finishing. Accordingly, there is a need for a varnish that has sufficient bond strength and processing characteristics even after extended air drying periods.

### SUMMARY OF THE INVENTION

A first aspect of the invention is a varnish composition comprising an acrylic copolymer compound, a cosolvent having at least one of amine and amide functionality and water. The acrylic copolymer compound, the cosolvent, and the water are in amounts sufficient to impart extended air dry characteristics to the varnish composition.

A second aspect of the invention is an inductive core for electrical equipment comprising plural laminations stacked on one another and a varnish composition on the laminations. The varnish composition comprises an acrylic copolymer compound, a cosolvent having at least one of amine and amide functionality, and water. The acrylic-copolymer compound, the cosolvent, and the water are in amounts sufficient to impart extended air dry characteristics to the varnish composition.

A third aspect of the invention is a method of manufacturing an inductive core for electrical equipment comprising the steps of stacking plural laminations on one another and coating a varnish composition on the laminations. The varnish composition comprises an acrylic-copolymer compound, a cosolvent having at least one of amine and amide functionality, and water. The acrylic-copolymer compound, the cosolvent, and the water are in amounts sufficient to impart extended air dry characteristics to the varnish composition.

A fourth aspect of the invention is a method of manufacturing an inductive core for electrical equipment comprising the steps of, stacking plural laminations on one another, coating the laminations with a varnish composition comprising an acrylic-polymer compound, a cosolvent having amine or amide functionality, and water, air drying the varnish composition after the coating step, and curing the varnish composition after the air drying step. The acrylic polymer compound, the cosolvent, and the water are in amounts sufficient to impart adequate strength to the varnish composition after the curing step to permit further operations on the inductive core, such as coil winding and finishing operations.

A fifth aspect of the invention is a method of manufacturing a varnish composition comprising the steps of providing an acrylic copolymer compound, providing a cosolvent having at least one of amine and amide functionality, and mixing the acrylic copolymer compound, the cosolvent, and water in amounts sufficient to impart extended air dry characteristics to the varnish composition.

### BRIEF DESCRIPTION OF THE DRAWING

The invention is described through examples and a preferred embodiment in connection with the attached drawing in which:

FIG. 1 is a perspective view of an inductive core in accordance with the preferred embodiment of the invention;

FIG. 2 is a sectional view of the inductive core of FIG. 1 taken along line 2-2 of FIG. 1;

FIG. 3 is a schematic illustration of the core of FIG. 1 in a deflection test apparatus; and

FIG. 4 is a graph of deflection of stator cores.

### DETAILED DESCRIPTION OF THE PREFERRED EMBODIMENT

The term “copolymer,” as used herein, refers to an elastomer produced by the simultaneous polymerization of two or more dissimilar monomers. The phrase “acrylic copolymer”, as used herein, refers to a copolymer of acrylic acid, methacrylic acid, esters of these acids, or acrylonitrile. The phrase “cosolvent having an amine or an amide functionality” refers to a cosolvent having one of the following functional groups:

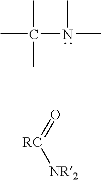

The term “laminations”, as used herein, refers to sheets, plates or other configurations, which are stacked on one another to define layers. The phrase “finishing operations” refers to any handling or processing of an inductive core after curing of the enamel.

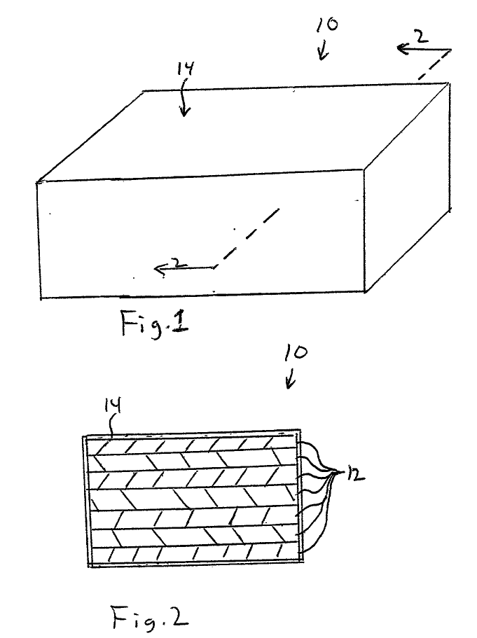

FIGS. 1 and 2 illustrate a preferred embodiment of an inductive core in accordance with the invention. Core 10 includes plural laminations 12 which are plates of a ferrous material. Laminations 12 are stacked on one another. A coating of varnish composition 14 is disposed on an outer surface of the stack of laminations 12. Varnish composition 14 can also extend into areas between laminations 12.

Applicant has developed a varnish composition having increased bond strength, shear strength and extended air drying characteristics. The phrase “extended air drying characteristics”, as used herein, refers to the characteristic of having a shear strength sufficient to permit finishing processes of an inductive core without significant skewing of laminations after 2 hours of air drying and a subsequent curing process. The phrase “air drying”, as used herein, refers to extended exposure of a varnish composition to ambient air at temperatures below a curing temperature, prior to a curing process.

A helical coil bond strength test procedure, as described in American Society of Testing Materials (ASTM) test procedure D2519-87, was used as an indication of the bond strength of varnish compositions. In the test procedure, ¼″ (6.35 mm) helical coils of GE Specification B22M62C magnet wire having a diameter of 0.0403″ (1.0236 mm) or annealed bare aluminum wire having a diameter of 0.0403″ (1.0236 mm) were coated with varnish compositions. The bond strength tests were conducted with an INSTRON test apparatus using a 1000 lb. (453.59 kg) compression cell and a known wedge-shaped attachment.

To make the coils, the wire was wrapped tightly around a ¼″ (6.35 mm) mandrel so all consecutive helices were in contact with one another. The winding apparatus included an aluminum block fixture having a nylon rod running therethrough. A hole is defined through the nylon rod for allowing passage of the wire. The wire was drawn through the fixture and secured to the shaft of a motor serving as the mandrel. The motor was started to pull the wire through the fixture and wind the wire on the motor shaft in a helical coil. The coils were cut to a length of 3″ (26.20 mm). The wire coils were then immersed in approximately 20% nonvolatile formulations of varnish compositions, allowed to drain for 30 minutes, inverted and redipped in the same varnish composition. The coated coils were then air dried at room temperature for the indicated periods from less than five minutes (i.e. “no air drying’) to two hours or more. The coils were then baked in a convection oven to cure the varnish composition in the manner described below. The following acrylic copolymer compounds were used in the varnish compositions:

BASF LUREDUR PR273 (PR273): Aqueous emulsion of acrylic/acrylonitrile/phenolic blend having about 40% nonvolatiles.

SCHENECTADY INTERNATIONAL ISOPOXY 800 (I 800): Water based epoxy-phenolic varnish having about 32% nonvolatiles;

MADER CORSOLAC M.E.N.4 (MEN4): aqueous emulsion of ethyl acrylate/butyl acrylate/acrylonitrile copolymer having about 50-52% nonvolatiles;

MADER CORSOLAC M.E.N.43 (MEN43): aqueous emulsion of ethyl acrylate/butyl acrylate/acrylonitrile copolymer and phenolic resin having about 42-46% nonvolatiles; and

DUPONT CAVALITE RCLE 6353 (RCLE 6353): acrylic-phenolic-varnish.

The following cosolvents were used in the varnish compositions:

BURDICK AND JACKSON NMP Gas Chromatography Grade, Product #304 (NMP):N-methyl pyrrolidine;

MALLINCKRODT ANALYTICAL DMF Reagent Grade (DMF): dimethyl formamide;

ALDRICH MORPHOLINE 99+% (MORPHOLINE): C₄H₉NO;

DOW CHEMICAL DOWANOL Pph: glycol ether solvent;

DOW CHEMICAL DOWANOL EPh: glycol ether solvent; and

DOW CHEMICAL DOWANOL PM (PGME): propylene glycol methyl ether.

The materials above were used to mix the following varnish composition examples for testing. Each example was mixed by combining the ingredients in a 20 ml vial and shaking the vial. The total weight of each formulation was about 20 grams.

All percentages are by weight.

### EXAMPLE 1

40% MEN4, 60% deionized water

### EXAMPLE 2

40% MEN4, 5% NMP 55% deionized water

### EXAMPLE 3

45% RCLE 6353, 55% deionized water

### EXAMPLE 4

40% MEN4, 5% PGME, 55% deionized water

### EXAMPLE 5

40% MEN4, 10% NMP, 50% deionized water

### EXAMPLE 6

45% MEN43, 55% deionized water

### EXAMPLE 7

45% MEN43, 5% NMP, 50% deionized water

### EXAMPLE 8

40% MEN4, 5% PGME, 55% deionized water

### EXAMPLE 9

40% MEN4, 5% DMF, 55% deionized water

### EXAMPLE 10

40% MEN4, 5% MORPHOLINE, 55% deionized water

### EXAMPLE 11

40% MEN4, 2% PGME, 58%, deionized water

### EXAMPLE 12

40% PR273, 2% PGME, 58% deionized water

### EXAMPLE 13

45% I800, 55% deionized water

Varnish compositions of Examples 1 and 2 were coated on coils made of both the GE B22M62C magnet wire and the bare aluminum wire and air dried for 2 hours prior to curing for 30 minutes at 90° C. and 30 minutes at 174° C. Table 1 below illustrates the results of the bond strength test under these conditions in accordance with ASTM test procedure D2519-87.

TABLE 1

| Example No. | 1 | 2 |
|---|---|---|
| Bond Strength (B22M62C) | 2.2 lbs. | 5.3 lbs. |
| Bond Strength (Aluminum) | 2.5 lbs. | 5.5 lbs. |

The test results illustrated in Table 1 indicate the unexpected result of bond strength being increased by a factor of more than 2 with the addition of 5% NMP (in Example 2) as a cosolvent and a commensurate reduction in the amount of deionized water.

To confirm the unexpected result noted above for various varnish compositions, two samples of each varnish composition of Examples 2-7 were coated on coils of aluminum wire, and cured for 30 minutes at 90° C. and 60 minutes at 180° C. One sample of each varnish composition was air dried for 2 hours and one sample was not air dried, i.e. was exposed to ambient, for less than 5 minutes. Table 2 below illustrates the results of this test in accordance with ASTM test procedure D2519-87.

TABLE 2

| Example No. | 2 | 3 | 4 | 5 | 6 | 7 |
|---|---|---|---|---|---|---|
| Bond Strength | 6.7 lbs. | 9.8 lbs. | 4.7 lbs. | 8.1 lbs. | 6.1 lbs. | 8.5 lbs. |
| (No Air Dry) | | | | | | |
| Bond Strength | 13.1 | 13.5 | 3.4 lbs. | 12.3 | 3.4 lbs. | 18.9 |
| (2 hr. Air Dry) | lbs. | lbs. | | lbs. | | lbs. |

The test results illustrated in Table 2 indicate that the benefit of increased bond strength is exhibited for Examples 2, 5, and 7 having NMP as a cosolvent. Also, NMP as a cosolvent was effective for increasing bond strength with MEN43 varnish also (compare examples 6 and 7). Significantly the bond strength of Example 2, 5, and 7 is comparable to that of Example 3 which includes RCLE6353 as a varnish.

To better understand what chemical properties in the cosolvent may be increasing bond strength, samples of each varnish composition of Examples 2, 8, 9, and 10 were coated on aluminum wire, air dried for 2 hours, and cured for 30 minutes at 90° C. and 60 minutes at 180° C. to compare bond strength for varnish compositions using NMP, DMF, MORPHOLINE, and PGME in accordance with ASTM test procedure D2519-87. These test results are illustrated in Table 3 below.

TABLE 3

| Example No. | 2 | 8 | 9 | 10 |
|---|---|---|---|---|
| Bond Strength | 10.8 lbs. | 4.0 lbs. | 10.7 lbs. | 11.3 lbs. |

The test results illustrated in Table 3 confirm that bond strength is increased by the use of NMP, DMF, or MORPHOLINE as a cosolvent, all of which contain amide or amine functions (Examples 2, 9, and 10) as compared to PGME as a cosolvent (Example 8).

Applicant also conducted tests of lamination skewing of stator cores manufactured using varnish compositions having NMP and PGME as cosolvents or without cosolvents. The varnish compositions of Examples 2 and 11-13 were used for the deflection test.

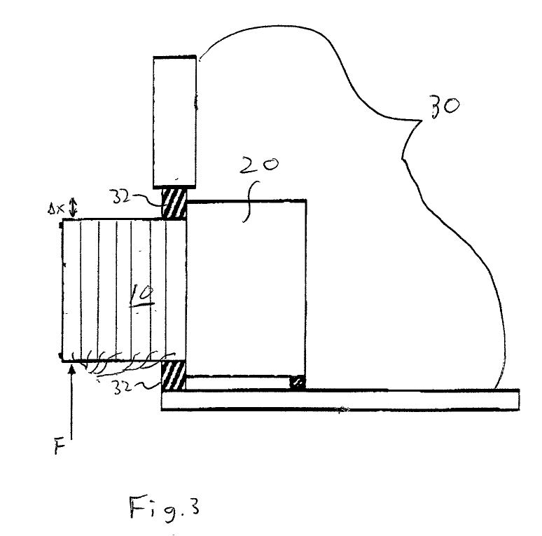

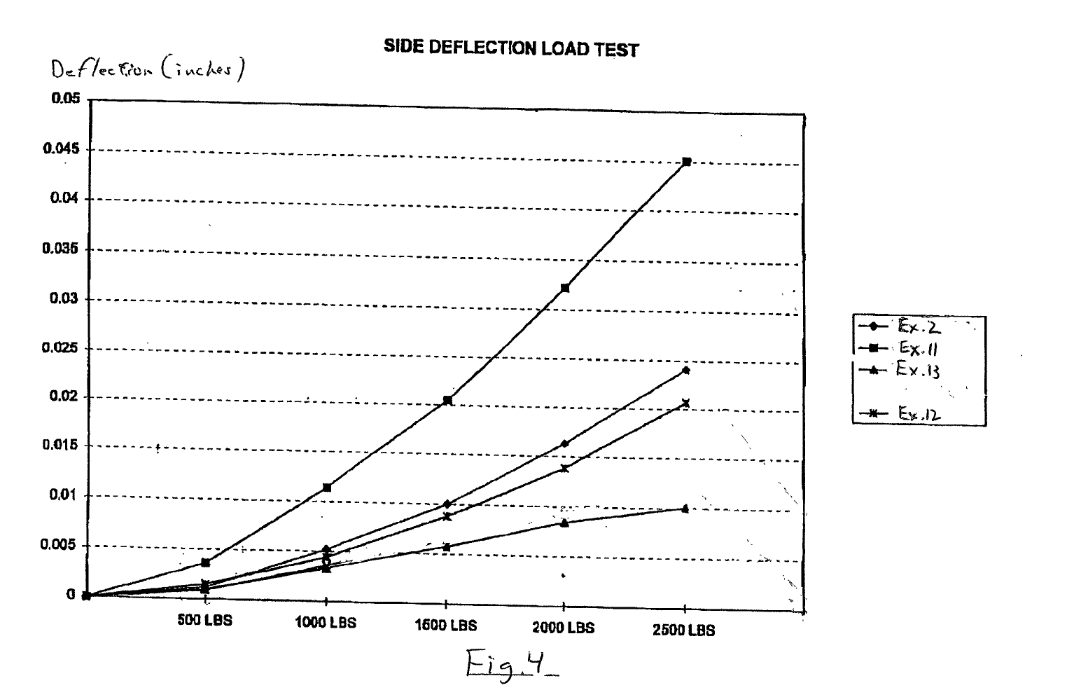

The deflection test procedure was conducted with 4.25″ high (107.95 mm) cores made from laminations that were 5⅝″ (142.88 mm) long and 5½″ (130.18 mm) wide, coated with the various varnish compositions and cured, as illustrated in FIG. 3. Each core 10 was bolted to a large casting 20 at a torque of 14 ft lbs. The core was then secured in arbor press 30 using 1″×1″ bar stock 32 extending the full width of core 10, in the illustrated manner. A force F was applied to the free end of core 10, parallel to the direction of the laminations 12 and deflection ΔX of the free end was measured as a function of force F. Deflection ΔX is a function of skewing of laminations 12, i.e. a larger deflection ΔX corresponds to greater amounts of skewing of laminations 12.

The test results illustrated in FIG. 4, which is a graph of deflection versus load on the laminations of each core, show that the varnish composition of Example 11, which includes PGME as a cosolvent for MEN4 varnish, has a relatively high deflection, i.e. large skewing. In contrast, the use of NMP as a cosolvent for MEN4 varnish, as in Example 2, yields low deflection and low skewing. Most significantly, the deflection of ΔX of Example 2 is similar to that of Examples 12 and 13, PR273 and I800 respectively, especially at shear forces below 1000 lbs.

Further, NMP, DOWANOL EPh, and DOWANOL PPh were used as cosolvents in varnish compositions of the following examples, having MEN4 and PR273 as varnish compounds more than one varnish compositions were subjected to testing in accordance with ASTM D2519-87. Each varnish composition was manufactured by placing the ingredients in a 20 ml vial and shaking.

### EXAMPLE 14

38% PR 273, 47% deionized water, 10% MEN4, and 5% NMP.

### EXAMPLE 15

38% PR 273, 47% deionized water, 10% MEN4, and 5% DOWANOL PPh.

### EXAMPLE 16

44% PR 273, 46% deionized water, 5% MEN4, and 5% DOWANOL PPh.

### EXAMPLE 17

38% PR 273, 50% deionized water, 10% MEN4, and 2% DOWANOL PPh.

### EXAMPLE 18

38% PR 273, 50% deionized water, 10% MEN4, and 2% DOWANOL EPh.

### EXAMPLE 19

37.1% PR 273, 53% deionized water, 16 g 9.9% MEN4.

### EXAMPLE 20

25% PR 273, 55% deionized water, and 20% MEN4.

### EXAMPLE 21

25% PR 273, 50% deionized water, 4.0117 g 20% MEN4, and 5% NMP.

### EXAMPLE 22

50% PR273, 45% deionized water, and 5% NMP

Helical coils were coated with a sample varnish composition of each of Examples 14-22 to yield sets of coated coils. Specifically, ¼″ (6.35 mm) ID helical coils of GE Specification B22M62C magnet wire were dipped into 20% nonvolatile formulations of the varnish compositions, left to stand for 30 minutes, inverted and dipped again in the same varnish composition. One set of coils was not air dried, i.e. was subjected to curing temperatures in less than 5 minutes after dipping, one set of coated coils was air dried for 2 hours prior to curing, and one set of coated coils was air dried for 6 hours prior to curing. One of the coils having the varnish of Example 22 was air dried for 4 hours. Curing for each coated coil was accomplished at 90° C. for 30 minutes then at 175-180° C. for 30 minutes.

After curing, the bond strength of the varnish compositions was determined on the ISOTRON 1125 test apparatus using the 1000 lb. (453.59 kg) compression cell and the wedge shaped attachment. The bond strength of each varnish composition is illustrated in Table 4 below which lists the materials as percentages by weight of the composition for ease of comparison between examples.

The test results clearly indicate the unexpected result that the use of NMP yields increased bond strength at air dry times of 2 hours or greater as compared to varnish compositions not using MNP as a cosolvent. Examples 14 and 21 include an acrylic-phenolic varnish (BASF PR 273), an acrylic varnish (MEN4) and NMP as a cosolvent. Example 22 has PR273, NMP, and water only for comparison. Preferably, the acrylic-phenolic varnish is in an amount of 20-45% by weight, the acrylic varnish is in an amount of 4-20% by weight, and the NMP is in an amount of 2-5% by weight.

TABLE 4

| SAMPLE NO. | 14 | 15 | 16 | 17 | 18 | 19 | 20 | 21 | 22 |
|---|---|---|---|---|---|---|---|---|---|
| BASF PR 273L | 38.0 | 38.0 | 44.0 | 38.0 | 38.0 | 37.1 | 25.0 | 25.0 | 50.0 |
| MEN4 | 10.0 | 10.0 | 5.0 | 10.0 | 10.0 | 9.9 | 20.0 | 20.0 | — |
| NMP | 5.0 | — | — | — | — | — | — | 5.0 | 5.0 |
| DOWANOL PPh | — | 5.0 | 5.0 | 2.0 | — | — | — | — | — |
| DOWANOL EPh | — | — | — | — | 2.0 | — | — | — | — |
| DEIONIZED WATER | 47.0 | 47.0 | 46.0 | 50.0 | 50.0 | 53.0 | 55 | 50 | 45 |
| BOND STRENGTH, LBS | | | | | | | | | |
| 0 HR AIR DRY | 14.8 | 4.1 | 5.3 | 4.4 | 3.7 | 1.0 | 1.8 | 10.8 | 20 |
| 2 HR AIR DRY | 8.0 | 3.7 | 4.0 | 2.5 | 3.1 | 2.5 | 1.0 | 3.9 | 3 |
| 4 HR AIR DRY | — | — | — | — | — | — | — | — | 2.5 |
| 6 HR AIR DRY | 4.1 | 2.8 | 2.1 | 1.8 | 2.0 | 1.6 | 0.7 | 2.1 | 2.5 |

From the testing above, Applicant has determined that a varnish composition having an acrylic copolymer compound and a cosolvent having at least one of amine and amide functions yields superior bond strength and permits a varnish composition of about 16-21% non volatiles to yield satisfactory results even after extended air dry times. Preferably, the varnish has 16-21% nonvolatiles when baked at 174° for 1 hour. Also, a varnish composition of 20-45% BASF LUREDUR PR273, 4-20% MADER CORSOLAC MEN4 and 2-5% NMP exhibits increased bond strength after extended air dry times.

The precise mechanism by which bond strength is increased is not understood completely at this time. However, it appears that the preferred cosolvents promote cross linking by acting as a volatile catalyst. For instance, when NMP is used as a cosolvent with MEN4 and PR273, the NMP can act as a Lewis base to react with the acrylonitrile functionality or hydrolyze an acrylic ester functionality. If both reactions occur simultaneously, the MEN4 acrylic chains may cross-link with the PR273 chains.

The invention has been described through a preferred embodiment and various examples. However, various modifications can be made without departing from the scope of the invention as defined by the appended claims.

What is claimed is:

1. A varnish composition comprising:
an acrylic copolymer;
a cosolvent including at least one of an amine and an amide functionality; and water;
said acrylic copolymer, said cosolvent, and said water being in amounts sufficient to impart extended air dry characteristics to the varnish composition.

2. A varnish composition as recited in claim 1 comprising water in an amount sufficient to yield 16-21% non-volatiles by weight.

3. A varnish composition as recited in claim 1, wherein said acrylic copolymer comprises at least one of an acrylic compound and an acrylic-phenolic compound.

4. A varnish composition as recited in claim 1, wherein said cosolvent comprises at least one of N-methyl pyrrolidone, dimethyl formamide, and MORPHOLINE.

5. A varnish composition as recited in claim 1 comprising 2-15% by weight of said cosolvent.

6. A varnish composition as recited in claim 1, wherein said acrylic copolymer compound comprises at least one of MADER CORSOLAC MEN4, MADER CORSOLAC MEN43, and MADER CORSOLAC MEN 48, and BASF LUREDER PR 273.

7. A varnish composition as recited in claim 1 comprising about 30-60% by weight of said acrylic copolymer.

8. A varnish composition as recited in claim 1 comprising about 40-45% by weight of said acrylic copolymer.

9. A varnish composition as recited in claim 1 wherein said water is deionized water.

10. A varnish composition as recited in claim 3, comprising 20-45% by weight of said acrylic-phenolic compound, 4-20% by weight of said acrylic compound, and 2-5% by weight of said cosolvent.

11. A varnish composition as recited in claim 10, wherein said water is deionized water.

12. An inductive core for electrical equipment comprising:
plural laminations stacked on one another; and
a varnish composition on said laminations, said varnish composition comprising an acrylic copolymer, a cosolvent including at least one of an amine and an amide functionality, and water, said acrylic-copolymer compound, said cosolvent, and said water being in amounts sufficient to impart extended air dry characteristics to said varnish composition.

13. An inductive core as recited in claim 12 wherein said varnish composition comprises water in an amount sufficient to yield 16-21% non-volatiles by weight.

14. An inductive core as recited in claim 12, wherein said acrylic copolymer comprises at least one of an acrylic compound and an acrylic-phenolic compound.

15. An inductive core, as recited in claim 12, wherein said cosolvent comprises at least one of N-methyl pyrrolidone, dimethyl formamide and MORPHALINE.

16. An inductive core as recited in claim 12 comprising 2-5% by weight of said cosolvent.

17. An inductive core as recited in claim 12, wherein said acrylic copolymer comprises at least one of MADER CORSOLAC MEN4, MADER CORSOLAC MEN43, MADER CORSOLAC MEN48, and BASF LUREDUR PR 273.

18. An inductive core as recited in claim 14, wherein said varnish composition comprises 20-45% by weight of said acrylic-phenolic compound, 4-20% by weight of said acrylic compound, and 2-5% by weight of said cosolvent.

19. An inductive core as recited in claim 12, wherein said water is deionized water.

20. An inductive core as recited in claim 12, wherein said laminations are configured as a motor stator core.

21. A method of manufacturing an inductive core for electrical equipment comprising the steps of:
stacking plural laminations on one another; and
coating a varnish composition on the laminations, the varnish composition comprising an acrylic-copolymer, a cosolvent including at least one of an amine and an amide functionality, and water, said acrylic-copolymer, said cosolvent, and said water being in amounts sufficient to impart extended air dry characteristics to the varnish composition.

22. A method as recited in claim 21, wherein the varnish composition in said coating step comprises water in an amount sufficient to yield 16-21% non-volatiles by weight.

23. A method as recited in claim 21, wherein said coating step comprises:
dipping the laminations in the varnish composition; and
curing the varnish composition on the laminations by heating the varnish composition.

24. A method as recited in claim 23, wherein said coating step further comprises removing excess of the varnish composition after said dipping step and before said curing step.

25. A method of manufacturing an inductive core for electrical equipment comprising:
stacking plural laminations on one another;
coating the laminations with a varnish composition comprising an acrylic-polymer, a cosolvent including amine or amide functionality, and water;
air drying the varnish composition after said coating step; and
curing the varnish composition after said air drying step;
the acrylic polymer, the cosolvent, and the water being in amounts sufficient to impart adequate strength to the varnish composition after said curing step to permit further operations on the inductive core.

26. A method as recited in claim 25, wherein the varnish composition in said coating step comprises water in an amount sufficient to yield 16-21% non-volatiles.

27. A method as recited in claim 26, wherein the water is deionized water.

28. A method as recited in claim 26, wherein said coating step comprises:
dipping the laminations in the varnish composition; and
curing the varnish composition on the laminations by heating the varnish composition.

29. A method as recited in claim 26 wherein said coating step further comprises removing excess of the varnish composition after said dipping step and before said curing step.

30. A method as recited in claim 27 wherein said air drying step lasts for 2 hours and the bond strength of the varnish composition after said curing step is 8.0 lbs or more.

31. A method as recited in claim 32, wherein said curing step comprises baking the varnish composition at 80-100° C. for 30 minutes and baking the varnish composition at 170-190° C. for 30 minutes.

32. A method as recited in claim 25, wherein the further operations comprise coil winding and finishing operations.

33. A method of manufacturing a varnish composition comprising the steps of:
mixing an acrylic copolymer, a cosolvent including at least one of amine and amide functionality, and water in amounts sufficient to impart extended air dry characteristics to the varnish composition.

34. A method as recited in claim 33 wherein the water in said mixing step comprises an amount sufficient to yield 16-21% non-volatiles by weight.

35. A method as recited in claim 33, wherein the acrylic copolymer comprises at least one of an acrylic compound and an acrylic-phenolic compound.

36. A method as recited in claim 33, wherein the cosolvent comprises at least one of N-methyl pyrrolidone, dimethyl formamide, and MORPHOLINE.

37. A method as recited in claim 33 wherein the cosolvent in said mixing step comprises 2-15% by weight of the varnish composition.

38. A method as recited in claim 33, wherein the acrylic copolymer compound comprises at least one of MADER CORSOLAC MEN4, MADER CORSOLAC MEN43, and MADER CORSOLAC MEN 48, and BASF LUREDER PR 273.

39. A method as recited in claim 33 wherein the acrylic copolymer compound in said mixing step comprises about 30-60% by weight of the varnish composition.

40. A method as recited in claim 33 wherein the acrylic copolymer compound in said mixing step comprises about 40-45% by weight of the varnish composition.

41. A method as recited in claim 33 wherein the water in said mixing step is deionized water.

42. A method as recited in claim 36, wherein said mixing step comprises mixing 20-45% by weight of the acrylic-phenolic compound, 4-20% by weight of the acrylic compound, and 2-5% by weight of the cosolvent.
